(19) United States
(12) Patent Application Publication
(10) Pub. No.: US 2004/0249714 A1
(43) Pub. Date: Dec. 9, 2004

(54) Method for purchasing a service

(76) Inventor: Gregor Ponert, Salzburg (AT)

Correspondence Address: Flynn Thiel Boutell & Tanis, 2026 Rambling Road, Kalamazoo, MI, 49008-1631, US

(21) Appl. No.: 10/482,091

(22) PCT Filed: Jun. 21, 2002
(86) PCT No.: PCT/EP02/06937

(30) Foreign Application Priority Data
Jun. 21, 2001 (DE) 101 30 061.1

(51) Int. Cl. G06F 17/60

(52) U.S. Cl. 705/15; 705/26

(57) ABSTRACT

For purchasing a service, especially an access authorization, by way of a mobile data terminal on a service or access terminal (6) a plurality of reservation terminals (2) for short-range wireless data transmission are established. In order to reserve a service, a link (3) between the mobile data terminal (4) and one of the reservation terminals (2) is established and the service is reserved using the data terminal (4). The reserved service is deposited either by data transfer (12) from the reservation terminal (2) to the data terminal (4) or after a transfer (14) of data for the identification of the data terminal (4) from the data terminal (4) to the reservation terminal (2) on the service terminal (6) or a data service (15) so as to purchase the service, that is for example to gain access.

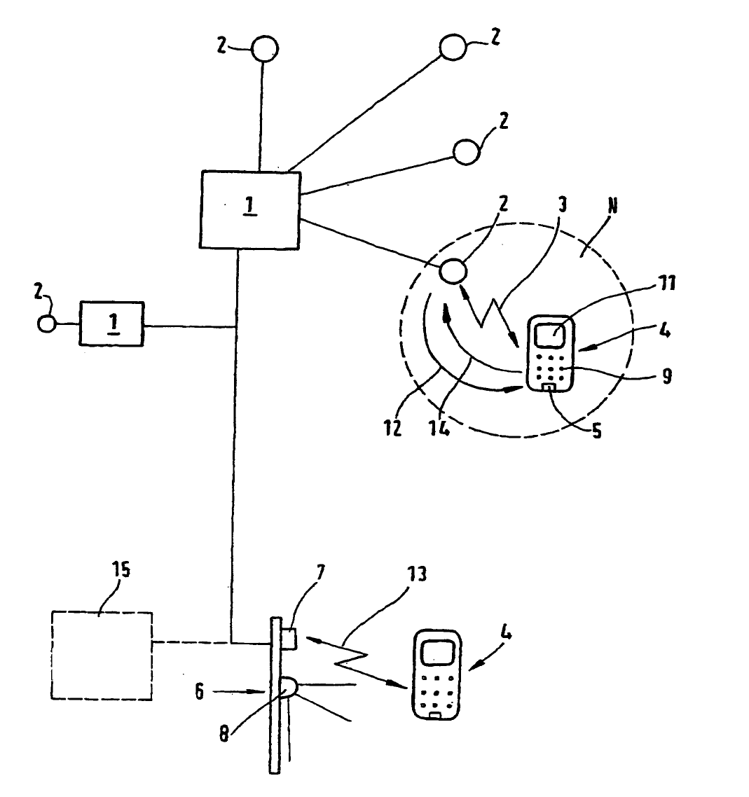

This invention relates to a method for acquiring a service, in particular an access authorization, with a mobile data terminal on a service terminal, in particular access terminal.

For access authorizations and utilizing other services it is usually necessary to book or acquire the service before consuming it. This is generally done by purchasing a ticket, i.e. an admission ticket, travel ticket, token or similar object, at a ticket office or pay machine. It is also possible to acquire the service by advance booking over the telephone or Internet.

For acquisition of the service, a ticket in physical form must thus be issued and handed over or sent by mail in case of advanced booking. Issuing and handing over the tickets involves considerable effort in setting up the ticket office and its personnel but also e.g. due to the ticket material. Since a ticket office or pay machine can only be used by one customer at a time, waiting lines are moreover usually unavoidable. Also, the ticket can go astray or be unavailable at the moment when the service is to be utilized.

The problem of the invention is to substantially facilitate the acquisition of a service.

This is achieved according to the invention with the method characterized in claim 1. The subclaims state advantageous embodiments of the inventive method.

The inventive method eliminates the need to acquire a separate physical ticket. Since setting up a booking terminal involves low costs, i.e. a large number of booking terminals can be set up, or one booking terminal can be employed by several users at a time, the problem of waiting lines forming is eliminated.

Instead of a separate ticket, the service acquirer can use as a data carrier for example an already existing electronic device, such as a mobile phone, which has an interface for noncontacting data exchange with a booking terminal. Thus, the conventional ticket office is replaced with the booking terminal which has an interface for wireless data transfer with the data carriers of the service acquirers.

Depending on the transfer medium used, the range of the booking terminal can be a few centimeters up to several meters. The range of the booking terminals can be such that one or more users can communicate with a booking terminal at a time. The booking terminals can be located at any desired publicly accessible places. They replace the ticket offices, pay machines and booking offices.

Transfer can be effected by radio or via an IR interface. Since the data exchange is more stable, a radio link is generally preferred. The radio link can be effected in particular via a Bluetooth interface. The data terminal, for example the mobile phone, is then equipped with a Bluetooth chip.

For booking the service, a connection setup is effected between the mobile data terminal and the particular booking terminal via the transfer medium used, e.g. radio according to the Bluetooth standard.

The connection setup can be initiated by the booking terminal or by the service acquirer. If the data terminal is formed for example by a mobile phone, the service acquirer can select a certain menu for data setup with the keyboard of the mobile phone. The connection setup can also be effected by speech control via a microphone on the data terminal. The desired service is then booked with the keyboard or by speech control.

A relatively large service offer can preferably be called up from the booking terminals, from which the service acquirer selects the desired service. Prompting and booking of the service can be effected for example by using “WAP over Bluetooth” or a standard Internet browser, i.e. the service acquirer can have the service offer displayed on the mobile phone by WAP.

The booked service can be deposited by data transfer directly in the service acquirer's mobile data terminal if the data terminal is formed for receiving coded information. That is, in this case the authorization to acquire the service is coded information on the mobile data terminal.

The coded information on the mobile data terminal is then read on the service terminal, which is located at the place where the service is provided, e.g. by an access terminal, and the service provided, for example the access enabled.

If the mobile data terminal is not formed for receiving the coded booking information, the booked service can be passed on after a transfer of data for identification of the data terminal to the booking terminal together with the identification data to the service terminal, for example to the access terminal, and stored there. The mobile data terminal must for this purpose have a unique feature, such as a serial number, by which it is uniquely identifiable.

The service or access terminal is provided for this purpose with a reading device for communication with the data terminal. If a plurality of service terminals or access terminals are used in one place, they can be preceded by a data center in which the data terminal identification data are stored. Communication between the reading device and the mobile data terminal can likewise be effected by Bluetooth radio.

For payment of the booked service it is suitable to use customary cashless payment methods, such as debiting credit cards, direct debiting, etc. If a mobile phone is used, it is expedient to effect payment via the mobile phone bill.

In the following the invention will be explained in more detail by way of example with reference to the enclosed drawing, the single figure showing a block diagram of an embodiment of the inventive method.

Accordingly, central computer 1 has connected thereto a plurality of booking terminals 2. Each booking terminal 2 is formed for wireless data transfer 3 in near zone N with one or more mobile data terminals 4. Data terminal 4 can be formed by a mobile phone and the transfer medium by Bluetooth radio. Mobile phone 4 is provided for this purpose with Bluetooth chip 5.

Mobile phone 4 can be used to acquire a service, for example an access through access terminal 6 having reading device 7 that drives turnstile 8.

For booking the service, connection 3 is set up between mobile phone 4 and one of booking terminals 2 e.g. according to the Bluetooth standard. To initiate the connection setup, the service acquirer can for example select a certain menu with keyboard 9. Via connection 3 the offered services are shown on display 11 of mobile phone 4. With keyboard 9 the service acquirer then selects the desired service and books the service. Prompting and booking of the service can be effected using “WAP over Bluetooth.”

The booked service can be coded by data transfer according to arrow 12 directly into mobile phone 4.

The coded information on mobile phone 4 is read on access terminal 6 with reading device 7 by communication 13 for example according to the Bluetooth standard, and turnstile 8 enabled.

Instead, after a transfer of data for identification of mobile data terminal 4, for example of its chip serial number, according to arrow 14 to booking terminal 2, the booked service can be transferred together with the identification data of data terminal 4 by telecommunication, for example the telephone network, to access terminal 6 and stored there. Said data can also be deposited on data server 15. When the service acquirer comes into the transmission zone of reading device 7 with mobile phone 4, turnstile 8 is then enabled upon positive comparison of the stored identification data and those deposited in mobile phone 4 by reading device 7.

Near zone refers here preferably to a range between 0.1 and 50 meters, in particular 1 to 20 meters.

1. A method for acquiring a service, in particular an access authorization, with a mobile data terminal (4) on a service terminal (6) having a reading device (7), characterized in that a plurality of booking terminals (2) are provided for wireless data transfer in the near zone with the data terminal (4), for booking the service a connection (3) is set up between the mobile data terminal (4) and one of the booking terminals (2) and the service is booked with the mobile data terminal (4), whereby either the booked service is deposited as coded information by data transfer (12) on the mobile data terminal (4) and transferred from the booking terminal (2) to the service terminal (6) or a data server (15) connected to the service terminal (6) and stored there, or after a transfer (14) of data for identification of the mobile data terminal (4) from the mobile data terminal (4) to the booking terminal (2) the identification data of the data terminal (4) are transferred together with the booked service to the service terminal (6) or the data server (15) connected thereto and stored there, whereby after the coded information deposited on the mobile data terminal (4) or the identification data of the mobile data terminal (4) are read by the reading device (7) on the service terminal (6) the booked service is enabled.

2. A method according to claim 1, characterized in that the service is selected before booking with the mobile data terminal (4).

3. A method according to claim 1 or 2, characterized in that the mobile data terminal (4) communicates with the service terminal (6) for acquisition of the service via the same transfer medium as for data transfer (12, 14) with the booking terminal (2).

4. A method according to claim 1, characterized in that a radio link or IR link is used as a transfer medium.

5. A method according to claim 4, characterized in that a radio link according to the Bluetooth standard is used.

6. A method according to claim 1, characterized in that the mobile data terminal (4) has a keyboard (9) or speech control for setting up and controlling the connection (3) with the booking terminal (2).

7. A method according to claim 2, characterized in that the mobile data terminal has a display (11) for showing the services bookable via the booking terminal (2).

8. A method according to claim 5, characterized in that a Bluetooth connection is provided and the bookable services are shown via W AP.
